(19) United States
(12) Patent Application Publication
(10) Pub. No.: US 2026/0361644 A1
(43) Pub. Date: Nov. 12, 2026

(54) DATA VERIFICATION METHOD, FIRST NETWORK ELEMENT DEVICE, AND STORAGE MEDIUM

(71) Applicants: CHINA MOBILE COMMUNICATION CO., LTD. RESEARCH INSTITUTE, Beijing (CN); CHINA MOBILE COMMUNICATIONS GROUP CO., LTD., Beijing (CN)

(72) Inventors: Feng YANG, Beijing (CN); Weiqiang CHENG, Beijing (CN)

(21) Appl. No.: 19/123,911

(22) PCT Filed: Oct. 23, 2023
(86) PCT No.: PCT/CN2023/125886

§ 371 Date: Apr. 24, 2025

(30) Foreign Application Priority Data
Oct. 25, 2022 (CN) 202211313340.0

(51) Int. Cl. H04L 45/00; H04L 12/46; H04L 45/745

(52) U.S. Cl. CPC H04L 45/34; H04L 12/4641; H04L 45/72; H04L 45/745

(57) ABSTRACT

The present disclosure provides a data verification method, a first network element device, and a computer readable storage medium. The method comprises: receiving a first Internet Protocol Version 6 segment routing SRv6 message sent by a second network element device; wherein the first SRv6 message is carrying virtual private network VPN information of the second network element device; and based on the VPN information, verifying the authorized access of the first SRv6 message.

### CROSS-REFERENCE TO RELATED APPLICATION

This application claims priority to Chinese Patent application filed on Oct. 25, 2022 with an application number of 202211313340.0, the content of which is hereby incorporated by reference in its entirety.

### TECHNICAL FIELD

The present disclosure relates to, but is not limited to, the field of communications, and in particular to a data verification method, a first network element device, and a computer-readable storage medium.

### BACKGROUND

The vigorous development of new internet services and the continuous emergence of new demands, along with the arrival of a 5th Generation Mobile Communication Technology (5G), cloud, and the era of ubiquitous intelligent connectivity, have brought new challenges to the innovation and transformation of network information technology, as well as an upgrading of information infrastructure. An Internet Protocol (IP) network, which serves as a cornerstone of global internet development, continues to address these challenges through technological innovation and continuous evolution.

Segment Routing (SR) is a source routing technology that assigns segments to nodes, links, or service functions within a network and combines these segments on-demand at a head node to form a segment sequence encapsulated in a message header. When a message arrives at ingress of an SR domain, the segment sequence may be pushed based on requirements, and the message is guided to the corresponding nodes, links, or service functions in sequence according to instructions in the segment sequence. Currently, SR supports two data planes: Multi-Protocol Label Switching (MPLS) and Internet Protocol Version 6 (IPV6). SR based on the IPV6 data plane is referred to as SRv6. SRv6 introduces a new Segment Routing Header (SRH) in a Routing Extension Header of IPV6 to carry a sequence of Segment Identifiers (SIDs) of SRv6, enabling flexible programming of network paths and various functions of SRv6. The SIDs of SRv6 has a length of 128 bits, consistent with IPV6 addresses. SIDs of SRv6 may be used to indicate various operations and parameters within the network flexibly, and a source routing mechanism can provide flexible scheduling of network paths by combine SIDs.

However, when the source routing combines SIDs, all network information is also encoded into the message. If an untrusted user device has received the message, the user device can invoke corresponding network resources directly based on the network information in the message, which may cause leakage of network information.

### SUMMARY

Embodiments of the present disclosure provide a data verification method, a first network element device, and a computer-readable storage medium.

According to a first aspect, there is provided a data verification method, applied to a first network element device, and the method includes the following operations.

A first Segment Routing over Internet Protocol Version 6 (SRv6) message sent by a second network element device is received. The first SRv6 message carries Virtual Private Network (VPN) information of the second network element device.

Authorized access verification is performed on the first SRv6 message based on the VPN information.

According to a second aspect, there is provided a first network element device, and the first network element device includes a receiving module and a processing module.

The receiving module is configured to receive a first Segment Routing over Internet Protocol Version 6 (SRv6) message sent by a second network element device. The first SRv6 message carries Virtual Private Network (VPN) information of the second network element device.

The processing module is configured to perform authorized access verification on the first SRv6 message based on the VPN information.

According to a third aspect, there is provided a first network element device, and the first network element device includes a memory and a processor.

The memory is configured to store executable instructions.

The processor is configured to implement the data verification method when executing the executable instruction stored in the memory.

According to a fourth aspect in the embodiments of the present disclosure, there is provided a chip for implementing the above data verification method. The chip includes a processor, which is configured to call and execute a computer program in a memory to cause a device equipped with the chip to implement the above data verification method.

According to a fifth aspect in the embodiments of the present disclosure, there is provided a computer-readable storage medium, which is configured to store a computer program that causes a computer to implement the above data verification method.

According to a sixth aspect in the embodiments of the present disclosure, there is provided a computer program product, which includes computer program instructions causing a computer to implement the above data verification method.

According to a seventh aspect in the embodiments of the present disclosure, there is provided a computer program that, when running on a computer, causes a computer to implement the above data verification method.

Through the above technical solution, the present disclosure provides a data verification method that not only meets the capability of flexible path scheduling via source routing but also verifies certain nodes along the path to fulfill security requirements. After a network element device has received a SRv6 message sent by another network element device, the network element device performs security verification based on the VPN information in the SRv6 message, thereby ensuring the security of network resources. The approach of simply adding VPN information to the SRv6 message is easy to implement, does not require upgrading router hardware, can be applied to communication scenarios of different scales, and does not significantly impact message forwarding efficiency.

### BRIEF DESCRIPTION OF THE DRAWINGS

FIG. 1 is a schematic diagram illustrating a process of accessing a Virtual Private Cloud (VPC) by a Customer Premises Equipment (CPE) provided in related technologies.

FIG. 2 is a schematic diagram illustrating hop-by-hop verification provided in related technologies.

FIG. 3 is a schematic diagram illustrating end-to-end verification provided in related technologies.

FIG. 4 is a schematic flowchart of a data verification method provided by an embodiment of the present disclosure.

FIG. 5 is a schematic diagram illustrating a format of a first SRv6 message provided in the present disclosure.

FIG. 6 is a schematic diagram illustrating a SRv6 Segment Identifier (SID) provided in the embodiments of the present disclosure.

FIG. 7 is a structural diagram of a data verification method provided by an embodiment of the present disclosure.

FIG. 8 is a flowchart illustrating a process that a source VPN verification table is configured through static configuration by a control device provided in the present disclosure.

FIG. 9 is a flowchart illustrating a process that a source VPN verification table is configured through dynamic distribution via a Border Gateway Protocol (BGP) by a control device provided in the present disclosure.

FIG. 10 is a schematic block diagram of a first network element device provided by an embodiment of the present disclosure.

FIG. 11 is a schematic structural diagram of a communication device provided by an embodiment of the present disclosure.

FIG. 12 is a schematic structural diagram of a chip provided by an embodiment of the present disclosure.

FIG. 13 is a schematic block diagram of a communication system provided by an embodiment of the present disclosure.

### DETAILED DESCRIPTION

Technical solutions in the embodiments of the present disclosure will be clearly and completely described below with reference to the drawings in the embodiments of the present disclosure. Words “another” or “yet another” mentioned in the description of the drawings does not refer to a specific embodiment, and various embodiments of the present disclosure may be combined with each other unless there is a conflict.

It should be understood that references throughout the description to “embodiments of the present disclosure” or “foregoing embodiments” mean that specific features, structures, or characteristics related to the embodiments are included in at least one embodiment of the present disclosure. Thus, the words “embodiments of the present disclosure” or “foregoing embodiments” appearing throughout the description may not necessarily refer to the same embodiments. Furthermore, these particular features, structures, or characteristics may be incorporated in any suitable manner to be applied in one or more embodiments. In various embodiments of the present disclosure, the size of the sequence number of the above-mentioned processes does not mean the order of execution, and the execution order of each process should be determined by its function and inherent logic, and should not be limited in any way to the implementation process of the embodiments of the present disclosure. The above serial numbers of the embodiments of the present disclosure are for description only and do not represent the advantages and disadvantages of the embodiments.

It is to be noted that embodiments of the present disclosure and features in the embodiments may be arbitrarily combined with each other unless there is a conflict.

Before explaining the present disclosure, a brief description of SRv6 in related technologies is provided herein.

SRv6 inherits all advantages of SR and gains stronger scalability and programmability through SR integration with IPV6. SRv6 has unique advantages in simplifying networks and meeting new service requirements, making it a core technology for a next-generation IP network. SRv6 also aligns with a technological direction suitable for requirements of Software Defined Wide Area Network (SD-WAN) application. The advantages of SR include the following four aspects.
(1) Simplified control protocols: SR distributes SIDs through Interior Gateway Protocol (IGP) and Border Gateway Protocol (BGP), eliminating the need to deploy and maintain traditional signaling protocols such as Label Distribution Protocol (LDP) and Resource ReSerVation Protocol-Traffic Engineering (RSVP-TE).
(2) High scalability: SR generates a vast number of SR paths by combining a limited number of links and node segments, and only a head node needs to store path information. Intermediate network nodes do not need to maintain state information for each path.
(3) Programmability: in the SR technology framework, a segment may be viewed as an instruction, and a formation of SR paths that meet specific requirements through the combination of segments may be viewed as a programming of the network. This programming may establish paths that meet different needs flexibly, thereby unlocking the value of the network.
(4) High reliability protection: SR can provide Fast Re-Route (FRR) protection with 100% network coverage, solving a long-standing technical challenge in IP networks, and achieving complete reliability protection while maintaining high scalability.

It is to be noted that the approach of source routing combines SIDs to provide flexible scheduling of network paths. However, all network information is also encoded into service messages through the source routing, leading to excessive control privileges on the user side. Similarly, extending SRv6 networks to untrusted user sides introduces a risk of unauthorized user invocation of network resources.

For example, in cloud scenarios, Customer Premise Equipment (CPE) corresponding to users is located in an untrusted domain. By specifying paths in service messages, users can access VPCs of other users illegally in addition to accessing their own Virtual Private Cloud (VPC), which brings security risks.

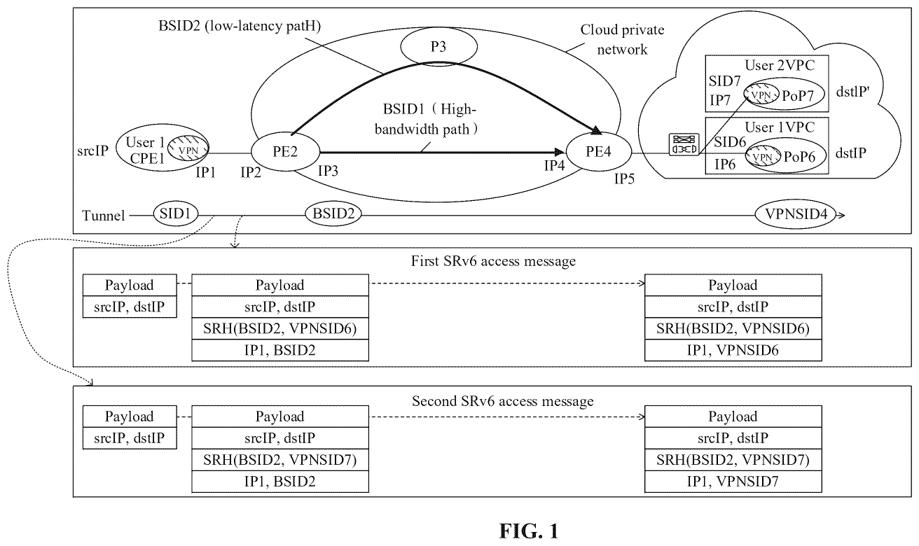

FIG. 1 is a schematic diagram illustrating a process of accessing a Virtual Private Cloud (VPC) by a CPE provided in related technologies. As illustrated in FIG. 1, Point-of-Presence (PoP) 6 is an entry point for a VPC corresponding to User 1, and PoP7 is an entry point for a VPC corresponding to User 2. A SRv6 access message of CPE1 corresponding to User 1 may be forwarded through Provider Edge (PE) 2 and PE 4 in sequence to PoP6 or PoP7. That is, CPE 1 transmits the SRv6 access message to PoP6 or PoP7 through a path corresponding to a specified Binding Segment Identity (BSID) 2, i.e., a high-bandwidth path. It is apparent that CPE 1 may access its own VPC as well as access VPCs of other users illegally. When CPE 1 accesses its own VPC, an SRH in a first SRv6 access message encapsulated by CPE 1 carries a path, i.e., BSID 2 and Segment ID information of the VPN in VPC of CPE1, i.e., VPNSID 6. The first SRv6 access message is transmitted through a tunnel to a next node and the first SRv6 access message is forwarded in sequence based on SRH content in the first SRv6 access message until PoP6 receives the first SRv6 access message, thus enabling CPE 1 to access its own VPC legally. When CPE1 accesses VPCs of other users, an SRH in a second SRv6 access message encapsulated by CPE1 carries a path, i.e., BSID 2 and Segment ID information of the VPN in VPCs of other users, i.e., VPNSID 7. The second SRv6 access message is transmitted through a tunnel to a next node and the second SRv6 access message is forwarded in sequence based on SRH content of the second SR v6 access message until PoP7 receives the second SR v6 access message, thus enabling CPE1 to access VPCs of other users illegally.

It is to be noted that the SRv6 access message also includes a source IP (srcIP) address and a destination IP (dstIP) address. A device corresponding to SID1 is connected to a tunnel corresponding to VPNSID4, and data may pass through a path corresponding to BSID2 during data transmission, where the tunnel is static. A cloud private network includes PE2, Provider (P) 3, and PE4. PE2 transmits service data to IP4 corresponding to PE4 through IP3, and a path between PE2 and PE4 includes a high-bandwidth path (i.e., BSID1) and a low-latency path (i.e., BSID2). CPE1 is directly connected to IP2corresponding to PE 2 through IP1, and PE 4 is indirectly connected to IP6 of POP6 of VPC of user 1 and IP7 of POP7 of VPC of user 2 through IP5. PE is an edge device of a service provider network and is directly connected to the CPE of the user. In the VPN, all processing for the VPN occurs on PE or PoP. P is a backbone device in the service provider network, and is not directly connected to CPE. P device does not perceive VPN, and only needs to have basic network forwarding capabilities. CPE1 may be a router or switch, or a host.

It is to be noted that SRv6 access message in FIG. 1 only indicates some fields of the SRv6 message. For example, a first SRv6 access message sent by CPE1 includes a source address IP1 of CPE1, and a transmission path, i.e., a path corresponding to BSID2. A first SRv6 access message received by PoP6 includes the source address IP1 of CPE1, and segment ID information in the VPC corresponding to PoP6, i.e., VPNSID6. A second SRv6 access message sent by CPE1 includes the source address IP1 of CPE1 and a transmission path, i.e., a path corresponding to BSID2. A second SRv6 access message received by PoP7 includes the source address IP1 of CPE1, and segment ID information in the VPC corresponding to PoP7, i.e., VPNSID7.

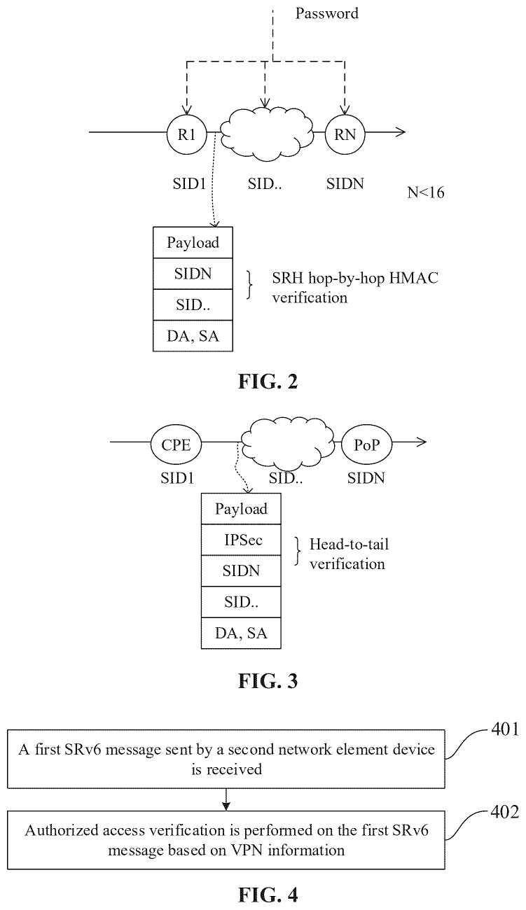

In related technologies, hop-by-hop verification, ingress verification, and end-to-end verification are typically adopted to prevent network information leakage. In hop-by-hop verification, a Hash-based Message Authentication Code (HMAC) is used to verify legal SRv6 paths. In ingress verification, traffic matching and filtering may be achieved by using Access Control Lists (ACL). In end-to-end verification, verification is performed at both CPE and PoP. FIG. 2 illustrates hop-by-hop verification provided in related technologies. For nodes R1 to RN, HMAC verification needs to be performed on every two adjacent nodes based on a password. The number of nodes in hop-by-hop verification is less than 16. Verifying the SRv6 access message via hop-by-hop verification involves HMAC verification for contents of Segment List[0] to Segment List[n] in a Segment List field of the SRv6 access message. Segment List[0] to Segment List[n] in the Segment List field of the SRv6 access message in FIG. 2 are represented by SID . . . to SIDN. Node R1 corresponds to SID1, and node RN corresponds to SIDN. The SRv6 access message includes Payload, Source Address (SA), and Destination Address (DA). SRv6 access message in FIG. 2 only indicates some fields of the SRv6 message. It is apparent that if the hop-by-hop verification is used, and if a current router hardware does not support HMAC computation, the hardware needs to be upgraded, which is costly. Router HMAC verification brings huge amount of computation, which will seriously affect the forwarding efficiency.

Ingress verification consumes substantial resources, with variable SID List length and substantial ACL resource consumption, making it applicable for small-scale deployments but not suitable for large-scale scenarios; ACL matching SID List is difficult to maintain and deploy in production.

FIG. 3 is a schematic diagram of end-to-end verification provided in related technologies. Mutual trust and message verification between the CPE and PoP may be achieved through the establishment of Transport Layer Security (TLS), Secure Socket Layer (SSL), Internet Protocol Security (IPSec), and other manners. SRv6 is encapsulated in an outer layer. A SID corresponding to CPE is SID1, and a SID corresponding to PoP is SIDN. Other nodes between CPE and PoP are other SIDs. As illustrated in FIG. 3, when validating SRv6 access messages using the end-to-end verification manner, an IPSec encapsulated in the outer layer of the SRv6 access message is head-to-tail authenticated. Segment List[0] to Segment List[n] in the Segment List field of the SRv6 access message are represented as SID . . . to SIDN in FIG. 3. The SRv6 access message in FIG. 3 indicates only some of the fields of the SRv6 message. The manner may prevent unauthorized access, but the manner requires network devices to encrypt all messages, which brings challenges to network performance and flexibility, and is unable to prevent Distributed Denial of Service (DDOS) attacks. Furthermore, since a current SRv6 connection cannot pass through in-cloud firewall devices located in a wireless core network data center, outer-layer encryption is still required when IPSec and TLS are used for inner-layer encryption, significantly affecting forwarding efficiency.

In related technologies, network routing includes a non-source routing mechanism and a source routing mechanism. For the non-source routing mechanism, all path information is stored within the network device, and the user-side device can only specify a destination address. For the source routing mechanism, full path information of an entire link is handed over to the user-side device, such as a specified CPE. Therefore, a balance needs to be found between the source routing mechanism and the non-source routing mechanism, on the one hand to meet the capability of source routing for flexible path scheduling, and on the other hand to validate partial nodes of the path to meet security requirements. Therefore, the present disclosure provides a data verification method that not only meets the capability of flexible path scheduling via source routing but also verifies certain nodes of the path to fulfill security requirements.

FIG. 4 is a schematic flowchart of a data verification method provided by an embodiment of the present disclosure. The method is applied in a first network element device or in a chip within the first network element device. As illustrated in FIG. 4, the method includes the following operations.

At 401, a first Segment Routing over Internet Protocol Version 6 (SRv6) message sent by a second network element device is received.

The first SRv6 message carries Virtual Private Network (VPN) information of the second network element device.

In the embodiments of the present disclosure, regardless of whether it is in a 2nd Generation Mobile Communication Technology (2G) network, a 3rd Generation Mobile Communication Technology (3G) network, a 4th Generation Mobile Communication Technology (4G) network, or a 5G network, network element devices do not exist in isolation. With requirements such as the expansion of network capacity, disaster recovery, and etc., network architecture may include a network element device cluster. A network element device cluster may include a plurality of network element devices. The network element device cluster may include a plurality of network element devices with different functions. The first network element device, also known as a host node, and the second network element device, also known as a source node, are any two nodes in a communication network that need to perform service transmission. For example, network element devices include but are not limited to access terminals, User Equipment (UE), subscriber units, subscriber stations, mobile stations, mobile terminals, remote stations, remote terminals, mobile devices, user terminals, terminals, wireless communication devices, user agents, or user apparatuses. Access terminals may be cellular phones, cordless phones, Session Initiation Protocol (SIP) phones, Internet of Things (IoT) devices, satellite handheld terminals, Wireless Local Loop (WLL) stations, Personal Digital Assistants (PDAs), handheld devices with wireless communication capabilities, computing devices, or other processing devices connected to wireless modems, vehicle-mounted devices, wearable devices, terminal devices in 5G networks, or terminal devices in future evolved networks.

In the embodiments of the present disclosure, the first network element device has received a first SRv6 message. The first SRv6 message includes an IPV6 header in the first SRv6 message, an SRH in the first SRv6 message, and a payload in the first SRv6 message.

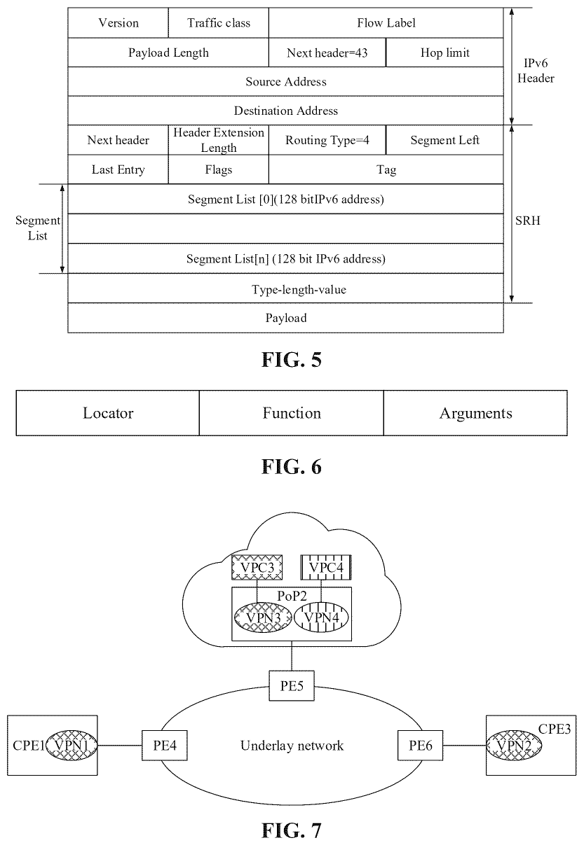

FIG. 5 is a schematic diagram of a format of a first SRv6 message provided in the present disclosure. As illustrated in FIG. 5, the IPV6 Header includes a Version field, a Traffic class field, a Flow Label field, a Payload Length field, a Next header field, a Hop limit field, a Source Address (SA) field, and a Destination Address (DA) field. The Version field occupies 4 bits and is used to represent an encapsulation format of the packet. The Traffic class field occupies 8 bits and is used to identify, by using a Differentiated Services Code Point (DSCP), how the traffic should be processed. The Flow Label field occupies 20 bits and is used to identify a Quality of Service (QoS). The Payload Length field occupies 16 bits and is used to represent a length of a data payload carried by the packet. The Next header field occupies 8 bits and is used to identify a type of a next-layer protocol. The Hop limit field occupies 8 bits and is used to represent a hop count limit for routing. The Source Address field and the Destination Address field each occupy 128 bits.

The SRH includes a Next Header field, a Header Extension Length (Hdr Ext Len) field, a Routing Type field, a Segment Left (SL) field, a Last Entry field, a Flags field, a Tag field, a Segment List field, and an Optional Type-length-value (TLV) field. The Next Header field occupies 8 bits and is used to represent a type of a message header immediately following the SRH. The Hdr Ext Len field occupies 8 bits and is used to represent a length occupied from Segment List[0] to Segment List[n]. The SL field occupies 8 bits and is used to represent the number of intermediate nodes that still need to be visited before reaching a destination node. The SL field may also be referred to as a remaining node field. The value of the SL field may indicate an active SID in the segment list. For example, if the segment list includes 5 SIDs, namely SID0, SID1, SID2, SID3, and SID4, and a value of SL is 2, it indicates that there are 2 unprocessed SIDs in the segment list, namely SID0 and SID1. The SID currently to be processed in the segment list is SID2, and the 2 SIDs that have been processed in the segment list are SID3 and SID4. The Last Entry field occupies 8 bits and is used to represent an index of a last element included in the segment list. The Flags field occupies 8 bits and is used to represent some identifiers of the packet. The Tag field occupies 16 bits and is used to identify packets in the same group. The Segment List field may include one or more SIDs, each of which may be in the form of an IPv6 address, so the segment list may also be understood as an explicit IPv6 address stack. The segment list may be denoted as Segment List[n], with a length of 128*n bits, and the segment list may be encoded starting from the last segment of the path. The segment list is in a form of an IPv6 address (i.e., 128-bit IPv6 address). The Optional TLV field is used to carry variable length data, providing better scalability for SRv6.

The payload of the first SRv6 message is, such as an IPV4 message, an IPv6 message, or an Ethernet (Eth) frame. The payload in the first SRv6 message may be called an original message. For example, in FIG. 5, the payload of the first SRv6 message is an IPv6 Payload.

In IPv6, some special functions, such as routing, are implemented by adding an extension header after the IPv6 Header. The Extension header is added only when needed. When a Next Header field in the IPv6 Header is 43, it indicates routing extension header. When the Routing Type field in the routing extension header is 4, it indicates that the routing extension header is a Segment Routing Header (SRH).

In the embodiments of the present disclosure, the SRv6 SID may include 128 bits. The SRv6 SID may be in hexadecimal data format. The format of the SRv6 SID may be X X:X:X:X:X:X:X. FIG. 6 is a schematic diagram of the SRv6 SID provided in the embodiments of the present disclosure. As illustrated in FIG. 6, the SID may include Locator information and Function information. The format of the SID is Locator: Function. Optionally, the SID may also include Arguments information, in which case the format of the SID is Locator: Function: Arguments. After the SRv6 SID is generated, the SRv6 SID is added to a Local SID table of a local device and advertised through routing protocols. During actual forwarding, the Locator part of the SRv6 SID is used to help other nodes in the network to perform routing and address finding, find a generating node of the SRv6 SID, and forward the SRv6 message to the node. The Function information is used to instruct the generating node of the SRv6 SID to perform corresponding functional operations. The Locator information is used for routing and forwarding packets and includes identifiers assigned to network nodes. The length of the Locator information may vary to adapt to networks of different scales. Identifiers in the Locator have two important attributes: routability and aggregability. The Function information is used to represent the forwarding action to be performed by the instruction, equivalent to an opcode of a computer instruction. In SRv6 network programming, different forwarding behaviors are expressed by different Functions. The Arguments information is an optional field, and is used to carry arguments required when executing the instruction. These arguments may include flow, service, or any other relevant information.

In the embodiments of the present disclosure, the VPN information of the second network element device carried in the first SRv6 message includes but is not limited to path information, VPN ID, instructions, and instruction-related parameters such as a VPN routing table ID, and an interface.

At 402, authorized access verification is performed on the first SRv6 message based on the VPN information.

In the embodiments of the present disclosure, the operation that the first network element device performs authorized access verification on the first SRv6 message sent by the second network element device based on the VPN information of the second network element device includes the following operations. It is first determined whether the second network device can access the first network device legally based on the VPN information, and only if the second network device can access the first network device legally, the first SRv6 message is processed; or it is directly determined whether the VPN information exists in the VPN information corresponding to devices allowed to access that are stored in the first network element device, and if the VPN information exists in the VPN information corresponding to the devices allowed to access that are stored in the first network element device, the first SRv6 message is processed.

It is to be noted that by analyzing a SD-WAN solution in related technologies, the present disclosure concludes that the security of the solution is guaranteed by the routing control of a VPN. The present disclosure considers that source routing carries and forwards path information in the path, and in order to achieve the same level of security, traffic source information can be verified based on the VPN. In this way, the advantages of source routing may be retained while meeting security requirements through verification at VPN endpoints. As illustrated in FIG. 7, traffic between CPEs needs to be verified at a node where a VPN of a traffic receiving end is located to meet basic security requirements. Based on VPN verification, it is determined that mesh VPNs may only access mesh VPNs and cannot access vertical VPNs. That is, VPN1, VPN2, and VPN3 may access each other, while VPN4 cannot access VPN1, VPN2, and VPN3. An underlay network in FIG. 7 is a bearer network composed of various physical devices, which ensures IP connectivity between devices through the use of routing protocols.

Embodiments of the present disclosure provide a data verification method, and the method includes the following operations. A first SRv6 message sent by a second network element device is received. The first SRv6 message carries VPN information of the second network element device. Authorized access verification is performed on the first SRv6 message based on the VPN information. In other words, the present disclosure provides a data verification method that not only meets the capability of flexible path scheduling via source routing but also verifies certain nodes along the path to fulfill security requirements. After a network element device has received a SRv6 message sent by another network element device, the network element device performs security verification based on the VPN information in the SRv6 message, thereby ensuring the security of network resources. The approach of simply adding VPN information to the SRv6 message is easy to implement, does not require upgrading router hardware, can be applied to communication scenarios of different scales, and does not significantly impact message forwarding efficiency.

The present disclosure is applicable to a SD-WAN system consisting of CPE network elements, PoP network elements, and controllers, as well as to PE routers whose forwarding plane operates the SRv6 protocol, including various manners such as C-SID and G-SID for SRv6 header compression.

In some embodiments of the present disclosure, the first SRv6 message in operation 401 includes a source address field of an Internet Protocol Version 6 (IPv6) Header, and the source address field carries a first VPN segment identifier; and the first VPN segment identifier includes the VPN information of the second network element device. In other words, an IPv6 extension header in the first SRv6 message, i.e., the Segment List field in the SRH, carries path information. The source address field in the IPv6 Header of the first SRv6 message carries source node information and VPN information, i.e., VPN SID. The source node information typically carries a loopback interface address, which may only identify node information and cannot identify VPN information.

In some embodiments, the operation 402 that authorized access verification is performed on the first SRv6 message based on the VPN information may be implemented through the following operations.

At operation A1, a source VPN verification table built into the first network element device is obtained.

The source VPN verification table carries a second VPN segment identifier that is authorized access and is associated with the first network element device.

In the embodiments of the present disclosure, the operation of obtaining in operation A1 may be understood as making, generating, getting/receiving, or determining. Regarding the timing of obtaining, it may be a first time of making/generating/getting/receiving/determining, or it may be update or adjustment of an existing source VPN verification table.

In the embodiments of the present disclosure, the second VPN segment identifier may be a single identifier or a plurality of identifiers.

In the embodiments of the present disclosure, the second VPN segment identifier carried in the source VPN verification table is configured through static configuration or dynamic distribution via a Border Gateway Protocol (BGP). The operation that the second VPN segment identifier in the source VPN verification table is configured through static configuration refers to a centralized planning and generation of VPN SIDs by a controller. Since the controller may be aware of VPN matching relationships between different devices based on service requirements, the VPN SIDs and the source VPN verification table may be configured by the controller directly through configuration means. The operation that the second VPN segment identifier in the source VPN verification table is configured through dynamic distribution via the BGP refers to that the control device dynamically configures a VPN segment identifier for the source VPN verification table built into the first network element device based on VPN segment identifiers carried in the BGP Update messages sent by other network element devices; or the first network element device updates the source VPN verification table built into the first network element device dynamically based on the VPN segment identifiers carried in the BGP Update messages sent by other network element devices directly.

At operation A2, authorized access verification is performed on the first SRv6 message based on the second VPN segment identifier and the first VPN segment identifier.

In some embodiments of the present disclosure, the first SRv6 message is forwarded if the first SRv6 message passes the authorized access verification; and the first SRv6 message is discarded if the first SRv6 message fails to pass the authorized access verification. In the present disclosure, upon receiving the SRv6 message, a verification operation based on VPN information of a source node in the SRv6 message is added. Considering that router devices all have a capability of looking up routing tables, so a source VPN verification table may be added, and this table is populated with authorized VPN SIDs for access. In this way, only messages that pass the verification are forwarded, while messages that fail to pass the verification are discarded.

In some embodiments, the operation that the first SRv6 message passes the authorized access verification may be that the first VPN segment identifier is the same as or partially the same as one of the second VPN segment identifiers.

In the embodiments of the present disclosure, the operation A1 that the source VPN verification table built into the first network element device is obtained may be implemented through operation B1.

At operation B1, a built-in source VPN verification table in which the second VPN segment identifier has been written by a control device is obtained.

The second VPN segment identifier is a VPN segment identifier that is filtered by the control device from a plurality of VPN segment identifiers based on a VPN service requirement and is used for accessing the first network element device.

It is to be noted that the VPN segment identifiers are generated by the control device; or, the VPN segment identifiers are generated by respective network element devices and sent to the control device. The respective network element devices include the first network element device and the second network element device.

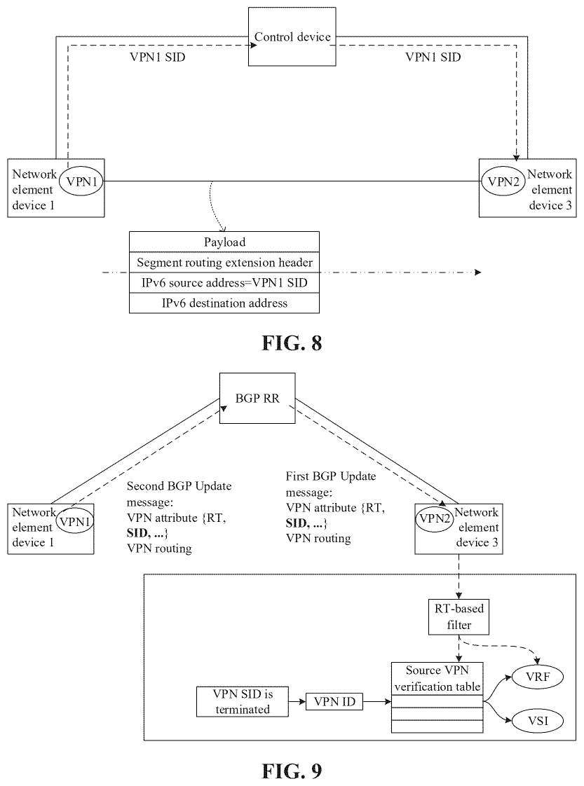

In some embodiments, a network element device, such as a CPE, generates a VPN SID. After the control device obtains the VPN SID generated by the CPE, the control device configures the source VPN verification table of the network element device to achieve information distribution. FIG. 8 is a flowchart illustrating a process that a source VPN verification table is configured through static configuration by a control device provided in the present disclosure. As illustrated in FIG. 8, network element device 1 generates a VPN1 SID and sends it to the control device; the control device then adds the VPN1 SID into the source VPN verification table of network element device 3. It is to be noted that when network element device 1 sends the VPN1 SID to the control device, the VPN1 SID is carried in the IPv6 source address field of the SRv6 access message.

In some embodiments, the network element device 1 in FIG. 8 may also directly send the VPN1 SID to network element device 3, and the VPN1 SID is carried in the IPv6 source address field of the SRv6 access message. The SRv6 access message in FIG. 8 only indicates some fields of the SRv6 message.

In some embodiments of the present disclosure, before obtaining the source VPN verification table built into the first network element device in operation A1, the method provided by the embodiments of the present disclosure also includes operation C1 or operation C2.

At operation C1, VPN segment identifier(s) is obtained through the following process: a control device configures a Route Reflector (RR), the second network element device generates and sends a BGP Update message to the RR, and the RR generates a first BGP Update message and sends the VPN segment identifier(s).

A VPN segment identifier attribute parameter in a second BGP Update message is associated with a BGP router (RT) attribute value; a BGP neighbor relationship is established between the RR and the first network element device; and a VPN segment identifier attribute parameter in the first BGP Update message is associated with a BGP RT attribute value.

In the embodiments of the present disclosure, the control device has the function of a BGP RR. Nodes, i.e., network element devices, also have BGP functionality. BGP neighbors are established between the nodes and the RR. A network element device, such as a CPE, generates a VPN SID, and dynamic information distribution is performed through the BGP.

In the embodiments of the present disclosure, the control device configures the RR, and the control device injects the VPN segment identifier(s) and the associated BGP RT attribute value(s) of the VPN(s) into the BGP RR through configuration.

In some embodiments, the second network element device generates a BGP Update message and sends it to the RR. The RR receives the BGP Update message and regenerates a first BGP Update message. Furthermore, the RR sends the first BGP Update message to the first network element device. The first network element device obtains the VPN segment identifier(s) and the associated BGP RT attribute value(s) of the VPN(s) from the first BGP Update message sent by the RR. In other words, the RR does not forward the received BGP Update message but terminates it; and the RR regenerates a first BGP Update message and sends it to the first network element device. The first BGP Update message carries the VPN segment identifier(s) and the associated BGP RT attribute value(s) of the VPN(s). It is to be noted that the BGP Update message is merely a carrier, and the core is the VPN SID and its associated RT attribute value.

It is to be noted that the VPN segment identifier(s) in the BGP Update message is associated with the BGP RT attribute value(s) in the BGP Update message.

In some embodiments, the first network element traverses local VPNs of the first network element device. When the RT attribute value(s) of the VPN(s) associated with the VPN segment identifier(s) in the first BGP Update message meets a first condition, the VPN segment identifier(s) in the first BGP Update message is written into a source VPN verification table of the local VPNs of the first network element device. In the embodiments of the present disclosure, the VPN segment identifier(s) in the first BGP Update message is ignored if RT attribute value(s) associated with the VPN segment identifier(s) in the first BGP Update message does not meet a first condition.

The operation that the RT attribute value(s) of the VPN(s) associated with the VPN segment identifier(s) in the first BGP Update message meets the first condition includes that the RT attribute value(s) associated with the VPN segment identifier(s) in the first BGP Update message is the same as the RT attribute value configured by the local VPNs of the first network element device.

It is to be noted that when the first network element device determines that the BGP RT attribute value(s) of the VPN(s) associated with the VPN segment identifier(s) in the first BGP Update message meets the first condition, some VPN segment identifiers are filtered from the first BGP Update message and filtered VPN segment identifiers are written into the source VPN verification table. Or, the first network element device does not need to filter the VPN segment identifier(s) carried in the first BGP Update message, and as long as the first network element device determines that the BGP RT attribute value(s) of the VPN(s) associated with the VPN segment identifier(s) in the first BGP Update message meets the first condition, all the VPN segment identifiers in the first BGP Update message are written into the source VPN verification table associated with the second VPN.

In some embodiments, the VPN segment identifier(s) and the BGP RT attribute value(s) of the VPN(s) associated with the VPN segment identifier(s) in a first BGP Update message are carried in a Nexthop field or a BGP Prefix Segment identifier (SID) field of the first BGP Update message.

FIG. 9 is a flowchart illustrating a process that a source VPN verification table is configured through dynamic distribution via a Border Gateway Protocol (BGP) by a control device provided in the present disclosure. As illustrated in FIG. 9, network element device 1 sends a BGP Update message to the BGP RR; the BGP RR generates a first BGP Update message based on the received BGP Update message and sends the first BGP Update message to network element device 3. The BGP Update message sent by network element device 1 carries attribute information and routing information corresponding to VPN1 of network element device 1. The attribute information of VPN1 includes an RT value and an SID. The first BGP Update message carries attribute information and routing information corresponding to VPN1 of network element device 1. The attribute information of VPN1 includes an RT value and an SID.

Furthermore, when the first network element device has received the first BGP Update message completely, i.e., the VPN SID is terminated, the first network element device obtains VPN information, such as a VPN ID, from the VPN SID in the first BGP Update message. At the same time, the first network element device obtains the RT attribute value associated with the VPN segment identifier from the first BGP Update message and compares the RT attribute value associated with the VPN segment identifier with RT values configured by local VPNs of all nodes in the network. When they are the same, the VPN ID in the first BGP Update message is written into the source VPN verification table, thereby realizing virtual routing forwarding or controlling corresponding network applications through a Virtual Switch Interface (VSI).

In some embodiments, for the VPN SID, network element device 1 sends the VPN SID to the RR through a BGP Update message, and the RR then propagates the VPN SID to network element device 3 through the first BGP Update message. When network element device 3 has received the first BGP Update message, network element device 3 installs the VPN SID matched with RT into the source VPN verification table through a mechanism of multiplexing BGP RT attribute comparison, thereby achieving automatic installation of the source VPN SID into the source VPN verification table of the host node.

It is to be noted that the BGP protocol stipulates that the Update message includes RT information, and each network element device configures a corresponding RT attribute locally for each VPN. The RT attribute carried in the BGP Update message is compared with all RTs configured by local VPNs. when they are the same, the routing information carried in the BGP Update message is imported into the VPN; when they are not the same, the BGP Update message is filtered out.

At operation C2, the first network element receives the VPN segment identifier(s) and the BGP RT attribute value(s) of the VPN(s) associated with the VPN segment identifier(s) in a case where the second network element device sends the VPN segment identifier(s) and the BGP RT attribute value(s) of VPN(s) associated with the VPN segment identifier(s) carried by a second BGP Update message to the first network element device.

A BGP neighbor relationship is established between the first network element device and the second network element device.

In the embodiments of the present disclosure, the second network element device may send a second BGP Update message to the first network element device directly without the need for routing through an RR. Of course, the second network element device may also send the second BGP Update message to the RR, the RR then generates a first BGP Update message based on the second BGP Update message and sends the first BGP Update message to the first network element device. That is, the BGP Update message generated by the second network element device and sent to the RR in operation C1 may also be the second BGP Update message in operation C2.

In some embodiments, the second network element device generates a second BGP Update message and sends it to the first network element device directly. Further, the first network element obtains the VPN segment identifier(s) and the BGP RT attribute value(s) of the VPN(s) associated with the VPN segment identifier(s) from the second BGP Update message in a case where the second network element device sends the VPN segment identifier(s) and the BGP RT attribute value(s) of VPN(s) associated with the VPN segment identifier(s) carried by a second BGP Update message to the first network element device.

In some embodiments, the first network element traverses local VPNs of the first network element device; and when the BGP RT attribute value(s) of the VPN(s) associated with the VPN segment identifier(s) in the second BGP Update message meets a first condition, the VPN segment identifier(s) in the second BGP Update message is written into a source VPN verification table of the local VPNs of the first network element device. The VPN segment identifier(s) in the second BGP Update message is ignored if an RT attribute value(s) associated with the VPN segment identifier(s) in the second BGP Update message does not meet a first condition.

The operation that the RT attribute value(s) of the VPN(s) associated with the VPN segment identifier(s) in the second BGP Update message meets the first condition includes that the RT attribute value(s) associated with the VPN segment identifier(s) in the second BGP Update message is the same as the RT attribute value configured by the local VPNs of the first network element device.

It is to be noted that when the first network element device determines that the BGP RT attribute value(s) of the VPN(s) associated with the VPN segment identifier(s) in the second BGP Update message meets the first condition, some VPN segment identifiers are filtered from the second BGP Update message and the filtered VPN segment identifiers are written into the source VPN verification table. Or, the first network element device does not need to filter the VPN segment identifier(s) carried in the second BGP Update message, and as long as the first network element device determines that the BGP RT attribute value(s) of the VPN(s) associated with the VPN segment identifier(s) in the second BGP Update message meets the first condition, all the VPN segment identifiers in the first BGP Update message are written into the source VPN verification table associated with the second VPN.

In some embodiments, the VPN segment identifier(s) and the BGP RT attribute value(s) of the VPN(s) associated with the VPN segment identifier(s) in a second BGP Update message are carried in a Nexthop field or a BGP Prefix Segment identifier (SID) field of the second BGP Update message.

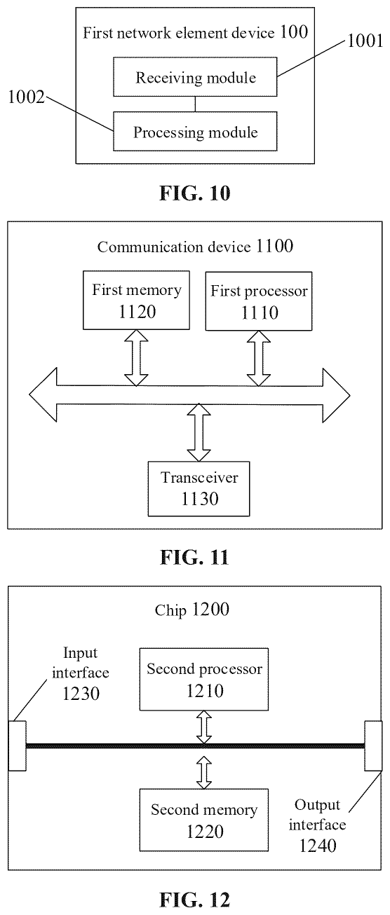

An embodiment of the present disclosure provides a first network element device, and the first network element device may be used to implement a data verification method provided by the embodiment corresponding to FIG. 4. Referring to FIG. 10, the first network element device 100 includes a receiving module 1001 and a processing module 1002.

The receiving module 1001 is configured to receive a first Segment Routing over Internet Protocol Version 6 (SRv6) message sent by a second network element device. The first SRv6 message carries Virtual Private Network (VPN) information of the second network element device.

The processing module 1002 is configured to perform authorized access verification on the first SRv6 message based on the VPN information.

In another embodiment of the present disclosure, the first SRv6 message includes a source address field of an Internet Protocol Version 6 (IPv6) Header, and the source address field carries a first VPN segment identifier; and the first VPN segment identifier includes the VPN information.

In other embodiments of the present disclosure, the processing module 1002 is configured to obtain a source VPN verification table built into the first network element device, where the source VPN verification table carries a second VPN segment identifier that is authorized access and is associated with the first network element device.

The processing module 1002 is configured to perform authorized access verification on the first SRv6 message based on the second VPN segment identifier and the first VPN segment identifier.

In another embodiment of the present disclosure, the processing module 1002 is configured to forward the first SRv6 message if the first SRv6 message passes the authorized access verification; and discard the first SRv6 message if the first SRv6 message fails to pass the authorized access verification.

In other embodiments of the present disclosure, the second VPN segment identifier carried in the source VPN verification table is configured through static configuration or dynamic distribution via a Border Gateway Protocol (BGP).

In other embodiments of the present disclosure, the processing module 1002 is configured to obtain a built-in source VPN verification table in which the second VPN segment identifier has been written by a control device.

The second VPN segment identifier is a VPN segment identifier that is filtered by the control device from a plurality of VPN segment identifiers based on a VPN service requirement and is used for accessing the first network element device.

In other embodiments of the present disclosure, the plurality of VPN segment identifiers are generated by the control device; or, the plurality of VPN segment identifiers are generated by respective network element devices and sent to the control device, where the respective network element devices include the first network element device and the second network element device.

In another embodiment of the present disclosure, the processing module 1002 is configured to obtain VPN segment identifier(s) through the following process: a control device configures a Route Reflector (RR), the second network element device generates and sends a BGP Update message to the RR, and the RR generates a first BGP Update message and sends the VPN segment identifier(s).

A VPN segment identifier attribute parameter in a second BGP Update message is associated with a BGP router (RT) attribute value; a BGP neighbor relationship is established between the RR and the first network element device; and a VPN segment identifier attribute parameter in the first BGP Update message is associated with a BGP RT attribute value.

In another embodiment of the present disclosure, the receiving module 1001 is configured to receive the VPN segment identifier(s) and the BGP RT attribute value(s) of the VPN(s) associated with the VPN segment identifier(s) by the first network element device in a case where the second network element device sends the VPN segment identifier(s) and the BGP RT attribute value(s) of VPN(s) associated with the VPN segment identifier(s) carried by a second BGP Update message to the first network element device, where a BGP neighbor relationship is established between the first network element device and the second network element device.

In other embodiments of the present disclosure, the processing module 1002 is configured to traverse local VPNs of the first network element device; and when the BGP RT attribute value(s) of the VPN(s) associated with the VPN segment identifier(s) in the first BGP Update message or in the second BGP Update message meets a first condition, write the VPN segment identifier(s) in the first BGP Update message or the second BGP Update message into a source VPN verification table of the local VPNs of the first network element device.

In another embodiment of the present disclosure, the receiving module 1001 is configured to ignore the VPN segment identifier(s) in the first BGP Update message or the second BGP Update message if RT attribute value(s) associated with the VPN segment identifier(s) in the first BGP Update message or the second BGP Update message does not meet a first condition.

In other embodiments of the present disclosure, the VPN segment identifier(s) and the BGP RT attribute value(s) of the VPN(s) associated with the VPN segment identifier(s) are carried in a Nexthop field or a BGP Prefix Segment identifier (SID) field of a BGP Update message.

In other embodiments of the present disclosure, meeting the first condition includes RT attribute value(s) associated with the VPN segment identifier(s) in a BGP Update message being the same as an RT attribute value configured by the local VPNs of the first network element device.

The above description of the device embodiment is similar to that of the above description of the method embodiment, and has similar beneficial effects as the method embodiment. Technical details not disclosed in the device embodiments of the present disclosure are understood by reference to the description of the method embodiments of the present disclosure.

It is to be noted that in the embodiments of the present disclosure, if the above data verification method is implemented in the form of a software function module and sold or used as an independent product, it may also be stored in a computer-readable storage medium. Based on such an understanding, the technical solutions according to embodiments of the present disclosure in essence or the part contributing to the prior art may be embodied in the form of a software product, and the computer software product is stored in a storage medium, which includes several instructions so that a terminal device implements all or part of the method according to respective embodiments of the present disclosure. The aforementioned storage medium includes various medium capable of storing a program code such as a USB disk, a mobile hard disk, a read-only memory (ROM) , a magnetic disk or a CD. In this way, the embodiments of the present disclosure are not limited to any specific combinations of hardware and software.

FIG. 11 is a schematic structural diagram of a communication device 1100 provided by an embodiment of the present disclosure. The communication device may be the first network element device/the second network element device, or the control device. A communication device 1100 illustrated in FIG. 11 includes a first processor 1110 that may call and execute a computer program from a memory to implement the method in an embodiment of the present disclosure.

Optionally, as illustrated in FIG. 11, the communication device 1100 may also include a first memory 1120. The first processor 1110 may call and execute a computer program from the first memory 1120 to implement the method in the embodiments of the present disclosure.

The first memory 1120 may be a separate device independent of the first processor 1110 or may be integrated in the first processor 1110.

As illustrated in FIG. 11, the communication device 1100 may also include a transceiver 1130. The first processor 1110 may control the transceiver 1130 to communicate with other devices, and in particular send information or data to other devices, or receive information or data sent by other devices.

The transceiver 1130 may include a transmitter and a receiver. The transceiver 1130 may further include antennas. The number of antennas may be one or more.

Optionally, the communication device 1100 may be specifically be a first network element device/a second network element device of the embodiments of the present disclosure, and the communication device 1100 may implement corresponding processes implemented by the first network element device/the second network element device in various methods of the embodiments of the present disclosure, which will not be repeated here for the sake of brevity.

Optionally, the communication device 1100 may be specifically a control device of the embodiments of the present disclosure, and the communication device 1100 may implement corresponding processes implemented by the control device in various methods of the embodiments of the present disclosure, which will not be repeated here for the sake of brevity.

FIG. 12 is a schematic structural diagram of a chip according to an embodiment of the present disclosure. As illustrated in FIG. 12, a chip 1200 includes a second processor 1210, which may call and execute a computer program from memory to implement the method in an embodiment of the present disclosure.

Optionally, as illustrated in FIG. 12, the chip 1200 may also include a second memory 1220. The second processor 1210 may call and execute a computer program from the second memory 1220 to implement the method in the embodiments of the present disclosure.

The second memory 1220 may be a separate device independent of the second processor 1210 or may be integrated in the second processor 1210.

Optionally, the chip 1200 may also include an input interface 1230. The second processor 1210 may control the input interface 1230 to communicate with other devices or chips, and in particular to obtain information or data sent by other devices or chips.

Optionally, the chip 1200 may also include an output interface 1240. The second processor 1210 may control the output interface 1240 to communicate with other devices or chips, and in particular to output information or data to other devices or chips.

Optionally, the chip may be applied to be a control device of the embodiments of the present disclosure, and the chip may implement corresponding processes implemented by the control device in various methods of the embodiments of the present disclosure, which will not be repeated here for the sake of brevity.

Optionally, the chip may be applied to be a first network element device or a second network element device of the embodiments of the present disclosure, and the chip may implement corresponding processes implemented by the first network element device or the second network element device in various methods of the embodiments of the present disclosure, which will not be repeated here for the sake of brevity.

It should be understood that the chip referred to in the embodiments of the present disclosure may also be referred to as a system-level chip, a system chip, a chip system or a system-on-chip or the like.

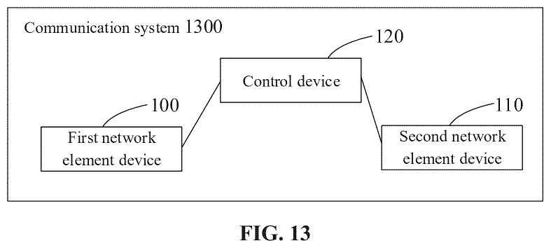

FIG. 13 is a schematic block diagram of a communication system 1300 provided by an embodiment of the present disclosure. As illustrated in FIG. 13, the communication system 1300 includes a first network element device 100, a second network element device 110, and a control device 120.

The first network element device 100 may be configured to implement corresponding functions implemented by the first network element device in the above method, the second network element device 110 may be configured to implement corresponding functions implemented by the second network element device in the above method, and the control device 120 may be configured to implement corresponding functions implemented by the control device in the above method, which will not be repeated here for the sake of brevity.

It should be understood that the processor of the embodiments of the present disclosure may be an integrated circuit chip having signal processing capabilities. In implementation, the actions of the above method embodiments may be accomplished by integrated logic circuitry of hardware in processor or instructions in the form of software. The processor may be a general purpose processor, a digital signal processor (DSP), an application specific integrated circuit (ASIC), a field programmable gate array (FPGA) or other programmable logic devices, discrete gates or transistor logic devices, or discrete hardware components. The processor may implement or execute the methods, actions and logic diagrams disclosed in the embodiments of the present disclosure. The general purpose processor may be a microprocessor or any conventional processor. The actions of the method disclosed in the embodiments of the present disclosure may be directly embodied as being executed by a hardware decoding processor or being executed by the hardware and software modules in a decoding processor. The software modules may be located in a storage medium mature in the art, such as a random access memory, a flash memory, a read-only memory, a programmable read-only memory or an electrically erasable programmable memory, a register, etc. The storage medium is located in the memory, and the processor reads the information in the memory to complete the actions of the aforementioned method in conjunction with its hardware.

As an embodiment, the processor may include one or more general-purpose central processing units (CPUs). Each of these processors may be a single-CPU processor or a multi-CPU processor. The processor herein may refer to one or more device, circuitry, and/or a processing core for processing data (e.g., computer-executed instructions).

It will be appreciated that the memory in the embodiments of the present disclosure may be a volatile memory or a non-volatile memory, or may also include both a volatile memory and a non-volatile memory. The non-volatile memory may be a read-only memory (ROM), a programmable ROM (PROM), an erasable PROM (EPROM), an electrically EPROM (EPROM) or a flash memory. The volatile memory may be a random access memory (RAM), which serves as an external cache. By way of illustration but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM). It is to be noted that the memory in the systems and methods described herein is intended to include, but is not limited to, these memories and any other suitable types of memory.

It should be understood that the memory described above is exemplary but not limiting. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM), etc. That is, the memory in the embodiments of the present disclosure is intended to include, but is not limited to, these memories and any other suitable types of memory.

In an embodiment of the present disclosure, there is further provided a computer-readable storage medium, for storing a computer program.

Optionally, the computer-readable storage medium may be applied to the first element device or the second element device of the embodiments of the present disclosure, and the computer program causes a computer to implement corresponding processes implemented by the first element device or the second element device in the methods of the embodiments of the present disclosure, which will not be repeated here for the sake of brevity.

Optionally, the computer-readable storage medium may be applied to the control device of the embodiments of the present disclosure, and the computer program causes a computer to implement corresponding processes implemented by the control device in the methods of the embodiments of the present disclosure, which will not be repeated here for the sake of brevity.

In the above-described embodiments, it may be implemented in whole or in part by software, hardware, firmware or any combination thereof. When implemented in software, it may be implemented in whole or in part in the form of a computer program product.

The computer program product includes one or more computer instructions. When the computer program instructions are loaded and executed on a computer, the flow or function described in accordance with embodiments of the present disclosure is generated in whole or in part. The computer may be a general purpose computer, a special purpose computer, a computer network, or other programmable device. The computer instructions may be stored in a computer-readable storage medium, or from one computer-readable storage medium to another. For example, the computer instructions may be transmitted from a web site, computer, server, or data center to another web site, computer, server, or data center via wired (e.g. coaxial cable, optical fiber, Digital Subscriber Line (DSL)) or wireless (e.g. infrared, wireless, microwave, etc.). The computer-readable storage medium may be any usable medium accessible to a computer or a data storage device containing one or more usable media integration, such as a server, data center, etc. The usable media may be magnetic media (e.g. floppy disk, hard disk, magnetic tape), optical media (e.g. digital video disc (DVD)), or semiconductor media (e.g. solid state disk (SSD)), etc.

The data verification method, the first network element device, and the computer-readable storage medium provided by the embodiments of the present disclosure have been described in detail above, and principles and embodiments of the present disclosure have been described herein by applying specific examples, and the description of the above embodiments is only for helping to understand the method of the present disclosure and an core idea thereof. Meanwhile, those skilled in the art may change the specific embodiments and the scope of application according to the idea of the present disclosure, and in summary, the contents of the present description should not be construed as limiting the present disclosure.

It should be understood that references throughout the description to “one embodiment” or “an embodiment” or “embodiments of the present disclosure” or “foregoing embodiments” or “some implementations” or “some embodiments” mean that specific features, structures, or characteristics related to the embodiments are included in at least one embodiment of the present disclosure. Thus, the words “in an embodiment” or “in one embodiment” or “embodiments of the present disclosure” or “foregoing embodiments” or “some implementations” or “some embodiments” appearing throughout the description may not necessarily refer to the same embodiments. Furthermore, these particular features, structures, or characteristics may be incorporated in any suitable manner in one or more embodiments. It should be understood that in various embodiments of the present disclosure, the size of the sequence number of the above-mentioned processes does not mean the order of execution, and the execution order of each process should be determined by its function and inherent logic, and should not be limited in any way to the implementation process of the embodiments of the present disclosure. The above serial numbers of the embodiments of the present disclosure are for description only and do not represent the advantages and disadvantages of the embodiments.

Unless otherwise specified, any operation in the embodiments of the present disclosure performed by the first network element device/the second network element device/the control device may be that the operation is performed by the processor of the first network element device/the second network element device/the control device. Unless otherwise specified, embodiments of the present disclosure do not limit a sequence in which the first network element device/the second network element device/the control device perform the following operations. In addition, the methods used to process data in different embodiments may be the same method or different methods.

In several embodiments provided in the present disclosure, it should be understood that the disclosed devices and methods may be implemented in other manners. The above-described device embodiments is only schematic, for example, the division of the units is only a logical function division, and in practice, there may be another division manner, for example, multiple units or components may be combined or integrated into another system, or some features may be ignored or not performed. Additionally, the coupling, or direct coupling, or communication connection of the components illustrated or discussed to each other may be indirect coupling or communication connection through some interfaces, devices or units, and may be electrical, mechanical or other form.

The above units illustrated as separate elements may or may not be physically separated, and the elements displayed as units may or may not be physical units, i.e. may be located in a place, or may be distributed over a plurality of network units. Some or all of the units may be selected according to actual needs to achieve the purpose of the solution of the present embodiments.

In addition, the functional units in each embodiment of the present disclosure may be integrated in a single processing unit, or each unit may be individually used as a unit, or two or more units may be integrated in a single unit. The integrated unit may be realized either in the form of hardware or in the form of hardware and software functional units.

The methods disclosed in several method embodiments provided in the present disclosure may be arbitrarily combined in as case of no conflict to obtain new method embodiments.

The features disclosed in several product embodiments provided in the present disclosure may be arbitrarily combined in as case of no conflict to obtain new product embodiments.

The features disclosed in several method or device embodiments provided in the present disclosure may be arbitrarily combined in as case of no conflict to obtain new method or device embodiments.

Those of ordinary skill in the art will appreciate that all or part of the operations of implementing the above method embodiments may be accomplished by hardware related to program instructions, the aforementioned program may be stored in a computer storage medium, and when the program is executed, the operations including the above method embodiments are executed. The aforementioned storage medium includes various medium capable of storing program codes such as a removable storage device, a ROM, a magnetic disk or an optical disk.

Alternatively, if the above integrated unit according to the present disclosure is implemented in the form of a software functional module and sold or used as an independent product, it may also be stored in a computer-readable storage medium. Based on such an understanding, the technical solutions according to embodiments of the present disclosure in essence or the part contributing to the prior art may be embodied in the form of a software product, and the computer software product is stored in a storage medium, which includes several instructions so that a computer device (may be a personal computer, a server, a network device or the like) implements all or part of the method according to respective embodiments of the present disclosure. The aforementioned storage medium includes mobile storage devices, ROM, disks or optical disks and other medium that may store program codes.

The singular forms of “a”, “said” and “the” as used in embodiments of the present disclosure and the appended claims are also intended to include a plural form, unless the context clearly dictates otherwise.

It is to be noted that in each embodiment of the present disclosure, all or part of the operations may be performed, as long as a complete technical scheme may be formed.

The above is only the implementation of the present disclosure, but the scope of protection of the present disclosure is not limited thereto. Any person skilled in the art may easily think of changes or substitutions within the technical scope disclosed in the present disclosure, which should be covered within the protection scope of the present disclosure. Therefore, the scope of protection of the application shall be subject to the scope of protection of the claim.

1. A data verification method, applied to a first network element device, and the method comprising:
receiving a first Segment Routing over Internet Protocol Version 6 (SRv6) message sent by a second network element device, wherein the first SRv6 message carries Virtual Private Network (VPN) information of the second network element device; and
performing authorized access verification on the first SRv6 message based on the VPN information.

2. The method of claim 1, wherein the first SRv6 message comprises a source address field of an Internet Protocol Version 6 (IPv6) Header, and the source address field carries a first VPN segment identifier; and
wherein the first VPN segment identifier comprises the VPN information.

3. The method of claim 2, wherein performing authorized access verification on the first SRv6 message based on the VPN information comprises:
obtaining a source VPN verification table built into the first network element device, wherein the source VPN verification table comprises a second VPN segment identifier that is authorized access and is associated with the first network element device; and
performing authorized access verification on the first SRv6 message based on the second VPN segment identifier and the first VPN segment identifier.

4. The method of claim 3, further comprising:
forwarding the first SRv6 message if the first SRv6 message passes the authorized access verification; and
discarding the first SRv6 message if the first SRv6 message fails to pass the authorized access verification.

5. The method of claim 3, wherein the second VPN segment identifier carried in the source VPN verification table is configured through static configuration or dynamic distribution via a Border Gateway Protocol (BGP).

6. The method of claim 3, wherein obtaining the source VPN verification table built into the first network element device comprises:
obtaining a built-in source VPN verification table in which the second VPN segment identifier has been written by a control device,
wherein the second VPN segment identifier is a VPN segment identifier that is filtered by the control device from a plurality of VPN segment identifiers based on a VPN service requirement and is used for accessing the first network element device.

7. The method of claim 6, wherein the plurality of VPN segment identifiers are generated by the control device; or
the plurality of VPN segment identifiers are generated by respective network element devices and sent to the control device, wherein the respective network element devices comprise the first network element device and the second network element device.

8. The method of claim 3, wherein before obtaining the source VPN verification table built into the first network element device, the method further comprises:
obtaining VPN segment identifier(s) through the following process: a control device configures a Route Reflector (RR), the second network element device generates and sends a BGP Update message to the RR, and the RR generates a first BGP Update message and sends the VPN segment identifier(s),
wherein a VPN segment identifier attribute parameter in a second BGP Update message is associated with a BGP router (RT) attribute value; a BGP neighbor relationship is established between the RR and the first network element device; and a VPN segment identifier attribute parameter in the first BGP Update message is associated with a BGP RT attribute value.

9. The method of claim 3, wherein before obtaining the source VPN verification table built into the first network element device, the method further comprises:
in a case where the second network element device sends VPN segment identifier(s) and BGP RT attribute value(s) of VPN(s) associated with the VPN segment identifier(s) carried by a second BGP Update message to the first network element device, receiving, by the first network element device, the VPN segment identifier(s) and the BGP RT attribute value(s) of the VPN(s) associated with the VPN segment identifier(s), wherein a BGP neighbor relationship is established between the first network element device and the second network element device.

10. The method of claim 8, further comprising:
traversing local VPNs of the first network element device; and
when BGP RT attribute value(s) of VPN(s) associated with VPN segment identifier(s) in the first BGP Update message or in the second BGP Update message meets a first condition, writing the VPN segment identifier(s) in the first BGP Update message or the second BGP Update message into a source VPN verification table of the local VPNs of the first network element device.

11. The method of claim 8, further comprising:
if BGP RT attribute value(s) associated with the VPN segment identifier(s) in the first BGP Update message or the second BGP Update message does not meet a first condition, ignoring the VPN segment identifier(s) in the first BGP Update message or the second BGP Update message.

12. The method of claim 8, wherein the VPN segment identifier(s) and the BGP RT attribute value(s) of the VPN(s) associated with the VPN segment identifier(s) are carried in a Nexthop field or a BGP Prefix Segment identifier (SID) field of a BGP Update message.

13. The method of claim 10, wherein meeting the first condition comprises BGP RT attribute value(s) associated with VPN segment identifier(s) in a BGP Update message being the same as an RT attribute value configured by the local VPNs of the first network element device.

14. (canceled)

15. A first network element device, comprising:
a memory, configured to store executable instructions; and
a processor, configured to, when the executable instructions stored in the memory is executed, perform:
receiving a first Segment Routing over Internet Protocol Version 6 (SRv6) message sent by a second network element device, wherein the first SRv6 message carries Virtual Private Network (VPN) information of the second network element device; and
performing authorized access verification on the first SRv6 message based on the VPN information.

16. A non-transitory computer-readable storage medium, having stored one or more programs, wherein the one or more programs is capable of being executed by one or more processors of perform:
receiving a first Segment Routing over Internet Protocol Version 6 (SRv6) message sent by a second network element device, wherein the first SRv6 message carries Virtual Private Network (VPN) information of the second network element device; and
performing authorized access verification on the first SRv6 message based on the VPN information.

17. The first network element device of claim 15, wherein the first SRv6 message comprises a source address field of an Internet Protocol Version 6 (IPv6) Header, and the source address field carries a first VPN segment identifier; and
wherein the first VPN segment identifier comprises the VPN information.

18. The first network element device of claim 17, wherein the processor is further configured to perform:
obtaining a source VPN verification table built into the first network element device, wherein the source VPN verification table comprises a second VPN segment identifier that is authorized access and is associated with the first network element device; and
performing authorized access verification on the first SRv6 message based on the second VPN segment identifier and the first VPN segment identifier.

19. The first network element device of claim 18, wherein the processor is further configured to perform:
forwarding the first SRv6 message if the first SRv6 message passes the authorized access verification; and
discarding the first SRv6 message if the first SRv6 message fails to pass the authorized access verification.

20. The first network element device of claim 18, wherein the second VPN segment identifier carried in the source VPN verification table is configured through static configuration or dynamic distribution via a Border Gateway Protocol (BGP).

21. The first network element device of claim 18, wherein the processor is further configured to perform:
obtaining a built-in source VPN verification table in which the second VPN segment identifier has been written by a control device,
wherein the second VPN segment identifier is a VPN segment identifier that is filtered by the control device from a plurality of VPN segment identifiers based on a VPN service requirement and is used for accessing the first network element device.
